(19) United States
(12) Patent Application Publication
(10) Pub. No.: US 2004/0111811 A1
(43) Pub. Date: Jun. 17, 2004

(54) Halogenated and sulfonated azodyes

(76) Inventors: David Anthony Akerman, Manchester (GB); John Anthony Taylor, Manchester (GB)

Correspondence Address: DINSMORE & SHOHL, LLP, 1900 CHEMED CENTER, 255 EAST FIFTH STREET, CINCINNATI, OH, 45202, US

(21) Appl. No.: 10/614,591

(22) Filed: Jul. 7, 2003

Related U.S. Application Data
(63) Continuation of application No. PCT/US02/00270, filed on Jan. 4, 2002.

(30) Foreign Application Priority Data
Jan. 5, 2001 (GB) 0100192.4

(51) Int. Cl. C09B 62/00

(52) U.S. Cl. 8/549

(57) ABSTRACT

Halogenated and sulfonated azodyes provide improved resistance to fading when washed by aqueous peroxy wash liquors. The dyes have the formula

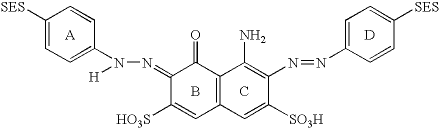

wherein X is fluorine, chlorine, bromine or iodine, R₁ is fluorine, chlorine, bromine, iodine, hydrogen or R₃, R₃ substituents are the same or different and are selected from SO₃H, NO₂, a fiber-reactive group or any moiety linked to the benzene ring by a carbon atom, n is 0, 1, 2 or 3 and m is 0, 1, 2 or 3.

The present invention relates to novel dyes, and fabrics and yarns dyed with them, which have improved fade resistance during washing with bleach-containing detergents.

A widely used fabric dye is the disazo compound CI Reactive Black 5 (also known as Everzol Black B). This compound is a compound of Formula 1

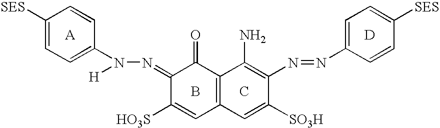

wherein SES is an abbreviation for sulphato-ethane-sulphonyl. SES is a reactive group which forms a vinyl sulphone under alkaline dyeing conditions. The vinyl sulphone group then, reacts with hydroxy or amino containing textile substrates with covalent bond formation, thus giving improved fastness. The oxygen substituent in ring B and the adjacent hydrazo group can alternatively be written as a hydroxy group and an azo group.

CI Reactive Black B is the largest selling reactive dye. By varying the concentration of Reactive Black 5 and by blending it with other dyes various colours can be obtained. Very large volumes of Reactive Black 5 are used as a fabric or yarn dye.

It is known that the rate of reaction of dyes with fibres can be raised by using different fibre-reactive groups, optionally in different positions, from the SES groups which are in the meta- or para-positions in rings A and D. It is also known that various other substitutents in the rings can give alternative dyes, some of which have similar colour effects to CI Reactive Black 5 and some of which give different colour effects.

Despite the very wide acceptance of CI Reactive Black 5, it does suffer from a disadvantage in that fibres dyed with it tend to fade in colour when washed with detergents containing a peroxy bleach, such as a detergent containing a bleach activator such as N,N,N′,N′-tetraacetylethylene diamine (TAED) and perborate or percarbonate. This fading is noticed primarily on lighter shades. Accordingly it would be desirable to be able to modify Reactive Black 5, and related dyes, in a simple and economic manner so as to maintain the desirable colour effects and cost effectiveness of the dyes whilst improving their fastness when washed with an aqueous detergent containing peroxy bleach.

One modification of the dyes is described in U.S. Pat. No. 4,485,041 in which the moiety containing rings A, B and C is linked to another moiety containing rings C, B and A through a triazine ring. The position in ring A which is ortho to the azo group is stated to be substituted by hydrogen, halogen, lower alkyl, lower alkoxy, hydroxy, carboxy or a sulphonic acid group.

The purpose of the substituents in the ortho position in ring A is to generate another hydroxy group in that ortho position, whereupon the two hydroxy groups can then complex heavy metals, such as copper. Accordingly, even though other substituents may initially be present in the ortho position in ring A, in actual use the substituent is another hydroxy group which can form the complex with a heavy metal.

Another modification of Reactive Black 5 is described in U.S. Pat. No. 4,492,654. This describes dyes which are said to have good dyeing properties and fastness. The dyes of U.S. Pat. No. 4,492,654 include dyes of Formula 2

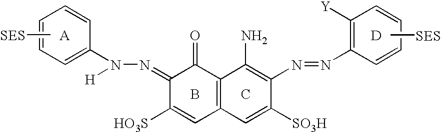

wherein Y is fluorine, chlorine or bromine and Z represents 1, 2 or 3 sulphonic-gro-ups and/or 1 or 2 substituents selected from nitro, lower alkoxy, lower alkyl, carboxy, fluorine, chlorine or bromine.

The problem solved by these dyes is the problem of changes in shade in the presence of copper ions in the dye liquor. The dyes are all said to give good dying properties and fastness similar to the dyes of the prior art, ie without the halogen Y. It appears that the presence or absence of the halogen Y makes no difference to the resistance to fading when fabrics dyed with this dye are washed with detergents containing a peroxy bleach.

There does not appear to have been any proposal to improve the fastness against peroxy-bleach containing wash liquors of dyes similar to CI Reactive Black 5 by varying the substitution in the rings of CI Reactive Black 5.

According to the invention, we provide novel dyes of Formula 3

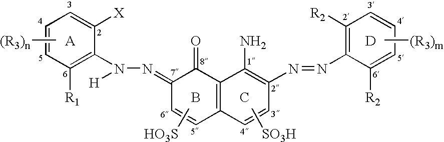

In this formula, X is fluorine, chlorine, bromine or iodine; R₁ is fluorine, chlorine, bromine, iodine, hydrogen or R₃; R₂ are the same or different and are H or R₃; R₃ substituents are the same or different and are selected from —SO₃H, —NO₂, a fibre reactive group or any moiety linked to the benzene ring by a carbon atom; n is 0, 1, 2 or 3; m is 0, 1, 2 or 3; and water soluble salts thereof, usually alkali metal salts especially sodium or potassium salts.

The essential presence of halogen in the 2 position of ring A as group X, andahydrogen or halogen in the 6 position as the group R₁, yields compounds which give improved fastness (especially of light shades) against peroxy-bleach containing wash liquors relative to compounds which do not have halogen in the 2 and 6 positions or halogen in the 2 position with the 6 position unsubstituted.

The invention follows from extensive research into the theories and the mechanisms by which fading may be caused of dyes such as CI Reactive Black 5 in the presence of peroxy containing aqueous detergent wash liquors. As a result of this we believe that the fading is due to simultaneous nucleophilic and electrophilic attacks on the C—O bond at the 8″ position and on the NH bond in the hydrazo group between rings A and B. The 2 halo or 2,6 halo substitution in ring A suppresses both the electrophilic attack and the nucelophilic attack.

In particular, we believe that CI Reactive Black 5 is attacked simultaneously by the nucleophilic species hydroperoxide, HOO⁻, and the electrophilic peracid HOOCOR. Both of these exist simultaneously in a conventional peroxy-containing wash liquor, which typically has a pH of around 10.4. We believe the peracid attacks the NH group while the hydroperoxy attacks the CO bond. Our present investigations indicate that the pKa for the NH group is in the range 9 to 11 when X and R₁ are both hydrogen but the introduction of halogen as X, and optionally also as R₁, modifies the pKa and, in any event, we believe it simultaneously reduces the attack of the hydroperoxide on the CO bond and of the peroxy acid on the NH bond.

Preferred compounds are those in which X is bromine or chlorine and R₁ is hydrogen, bromine or chlorine. Chlorine is generally-preferred. R₁ is preferably hydrogen.

The groups R₂ are preferably hydrogen and/or SO₃H and often both are hydrogen. The SO₃H groups in rings C and B are preferably in the 3″ and 6″ positions. Preferably there is a fibre reactive group, generally SES, in both rings A and D.

Preferred compounds have an SES group or other fibre reactive group in ring A and/or in ring D at a position meta or para to the azo group, and the sulphonic group in ring C is preferably at a position ortho to the azo group in ring C. Thus the preferred compounds are derivatives of Reactive Black 5 achieved solely by introducing halogen at the 2-position and optionally the 6-position in the ring A.

In general, the groups R₃ can be selected individually from hydrogen, fibre-reactive groups, alkyl, alkoxy, acylamino, cyano, —COOH, —COOR₄ where R₄ an esterifying group such as alkyl, —SO₃H (or a salt) or —NO₂.

Usually there are not more than two fibre reactive groups in ring A and there are not more than two fibre reactive groups in ring D, and generally there are not more than three fibre reactive groups in rings A and B combined. Usually there is one fibre reactive group in one of the rings and zero or one fibre reactive group in the other ring.

The preferred fibre reactive group is SES but, in general, preferred fibre reactive groups can be defined as having the formula —SO₂Y where Y is β-sulphatoethyl, β-chloroethyl, β-thiosulphatoethyl, vinyl, quaternary ammonium ethyl or β-acyloxyethyl where the acyl radical is the radical of an alkane carboxylic acid or of a benzoic acid or of a benzene sulphonic acid.

Other groups which act as fibre reactive groups are the corresponding compounds in which the SO₂ group in —SO₂Y is replaced by another electron withdrawing group such as —NHCO—. Other fibre-reactive groups are heterocyclic groups having the Formulae 4 or 5, optionally linked to rings A or D through a —NH group:

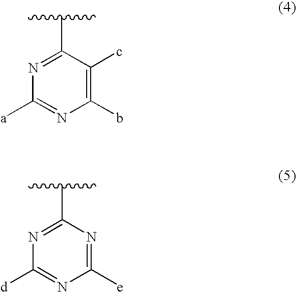

In these, a to e are halogen, especially fluorine or chlorine, or other atoms or groups which are readily displaced by nucleophilic species such as cellulosate, for instance —SO₂CH₃, —SO₃⁻Na⁺, —N⁺R₃ (such as —N⁺Me₃ and compounds of formula 6

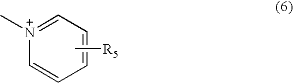

wherein R₅ is H or COOH (meta or para).

All these fibre-reactive groups may be selected in known manner from a wide range of electrophilic species which react with hydroxyl groups of hydroxyl-containing fibres such as cellulose (including cotton) and viscose or amino groups of fibres such as wool or polyamide (nylon).

The compounds of the invention may be made by coupling appropriately substituted diazo components which provide rings A and D with an appropriate coupling component which provides rings B and C, for instance by the general method described in U.S. Pat. No. 4,492,654.

The compounds can be used to dye suitable fibres, generally cotton, viscose or other cellulose fibres, nylon or wool fibres by conventional dyeing techniques. Dyeing may be conducted onto the fibres in freeform, generally as yarn, or in preformed fabric form, for instance a non-woven or, more usually, a woven or knitted fabric. The fabric is generally of the type which would conventionally be laundered frequently using aqueous detergents containing a bleach, for instance towelling or clothing fabrics.

Whenever a dye is supplied to the industry, the manufacturer needs to make warranties as to its performance, and thus show the performance of the dye under standard conditions, such as under a standard aqueous detergent peroxy bleach wash. Once the dye has become accepted as an industry standard, it may no longer be necessary for the manufacturer to continue to show what the properties of the dye are since the customer will buy the dye knowing the previously published properties of it. Nevertheless that use of the dye by the customer is still associated with the original showing of the properties of the dye in an aqueous detergent containing peroxy bleach. The invention is of particular value in all those situations where the customer needs a dye which has been shown to have good wash fastness when washed with an aqueous detergent containing a peroxy bleach such as perborate or percarbonate. For convenience, the industry standard is usually an aqueous detergent containing a perborate bleach. Any showing utilising such a detergent, or any other detergent which is indicative of fastness to peroxy bleaches, can be relied upon in the invention.

A suitable test, the UK-TO test, for determining fastness in an aqueous detergent containing peroxy bleach is given below, but the invention is not limited to the use of this particular test. This test predicts, in a single cycle test, the behaviour of an article on repeated laundering in presence of an oxidative bleach containing aqueous detergent.

### EXAMPLE 1

Preparation of 1-amino-2-(4-[2-sulphatoethanesulphonyl-phenylazo)-7-(2-chloro-4-[2-sulphatoethanesulphonyl-]phenylazo)-8-amininaphthalene-3,6-disulpholnic acid.

(a) 1-amino-2-(4-[2-sulphatoethanesulphonyl-]phenylazo)-8-aminonaphthalene-3,6-disulphonic Acid

4-(2-sulphatoehtanesulphonyl)-aniline (95.4% strength, 14.7 g, 0.05 mol) was stirred in water (20 ml) and sodium hyderoxide solution was added dropwise to give a solution of pH 7. Sodium nitrite (3.6 g, 0.0525 mol) was added and the solution was cooled to 5° C. before adding, over 30 minutes, to an ice cold stirred solution of hydrochloric acid (21.5 ml, 32.5% w/v) in water (59 ml). After stirring for an additional 30 minutes excess nitrous acid was destroyed by the addition of a small amount of sulphamic acid. H-acid, 1-hydroxy-8-aminonaphthalene-3,6-disulphonic acid (82.2% strength, 19.4 g, 0.05 mol), in water (25 ml) was dissolved by adding sodium hydrogen carbonate and the resulting freshly prepared solution was added to the cold diazonium salt prepared above at pH<2. The reaction was monitored by thin layer chromatography which indicated, after 2 hours, the presence of a red material together with a trace of H-acid. Salt (3% w/v) was added slowly to the stirred solution and the resulting precipitated solid, the desired product which was essentially homogeneous as judged by thin layer chromatography, was collected and dried.

Yield 26.5 g (49% at 49.8% e.a. strength)

(b) 1-amino-2-(4-[2-sulphatoethanesulphonyl-]phenylazo)-7-(2-chloro-4-[2-sulphatoethanesulphonyl-]phenylazo)-8-aminonaphthalene-3,6-disulphonic Acid

A solution of 2-chloro-4-(2-sulphatoethanesulphonyl)benzene diazonium chloride (0.0025 mol), prepared by a procedure similar to that described above, was added to a solution of 0.025 mol of 1-amino-2-(4-sulphatoethanesulphonylphenylazo)-8-aminonaphthalene-3,6-disulphonic acid at pH 7 and 0° C. The solution was allowed to warm to room temperature. Isolation of a solid product proved difficult and thus the product, which was essentially homogeneous, as judged by thin layer chromatography, was used direct.

### EXAMPLE 2

Preparation of 1-amino-2-(4-[2-sulphatoethanesulphonyl-]phenylazo)-7-(2-bromo-4-[2-sulphatoethanesulphonyl-]phenylazo)-8-aminonaphthalene-3,6-disulphonic acid.

This material was prepared by a similar method to that described above except that 2-bromo-4-(2-sulphatoethanesulphonyl)benzene diazonium chloride (0.0025 mol) was used in place of the 2-chloro-4-(2-sulphatoethanesulphonyl)benzene diazonium chloride (0.0025 mol) employed in 1(b) above.

### EXAMPLE 3

Preparation of 1-amino-2-(4-[2-sulphatoethanesulphonyl-]phenylazo)-7-(2,6-dichlbro-4-(2-sulphatoethanesulphonyl-]phenylazo-8-aminonaphthalene-3,6-disulphonic acid 2,6-dichloro-4-(2-sulphatoethanesulphonyl)benzene diazonium chloride (0.065 mol) was diazotised with nitrous acid, prepared by dissolving sodium nitrite (4.5 g, 0.065 mol) in ice cold dilute hydrochloric acid. This was then added to a solution of 1-amino-2-(4-[2-sulphatoethanesulphonyl-]phenylazo)-8-aminonaphthalene-3,6-disulphonic acid (0.065 mol) at 0° C. and pH 6 to 7. After 2 hours the stirred solution was allowed to warm to room temperature, and potassium chloride was added slowly to the stirred solution until the desired product was precipitated.

Yield 47.4 g. Mole In=1732, 42%.

Other compounds can be made in the same manner as in Example 1 except for the following variations in X, R₁ and R₃.

| Example | X | R₁ | ring A | ring D |
|---|---|---|---|---|
| 4 | Cl | H | 4 SES | 4 SO₃H |
| 5 | Cl | H | 4 SES | 5 SES |
| 6 | Cl | H | 5 SES | 4 SES |
| 7 | Br | H | 4 SES | 4 SO₃H |
| 8 | Br | H | 4 SES | 5 SES |
| 9 | Cl | Cl | 4 SES | 4 SO₃H |
| 10 | Cl | Cl | 4 SES | 5 SES |
| 11 | Cl | Cl | 5 SES | 4 SES |
| 12 | Br | Br | 4 SES | 4 SO₃H |
| 13 | Cl | H | 4 SES | H |
| 14 | Cl | H | 4 SES | 2-SO₃H-4-MFT |
| 15 | Cl | H | 5 SES | 2-SO₃H-5-MFT |
| 16 | Cl | Cl | 4 SES | 2-SO₃H-4-Pyr |
| 17 | Cl | Cl | 5 SES | 2-SO₃H-5-Pyr |
| 18 | Cl | H | 4 SES | 2-SO₃H-5-DCTTr |
| 19 | Cl | H | 4 SES | 2-SO₃H-5-MCT |
| 20 | Cl | H | 4 SES | 2-SO₃H-4-MFT |

In these, MCT, MFT, Pyr and DCT are groups of formulae 4 or 5 linked to the appropriate ring through a NH group. MCT is the compound of formula 5 where d is Cl and e is amine, MFT is the compound of formula 5 in which d is fluorine and e is amine, DCT is the compound of formula 5 in which d and e are both chlorine and Pyr is the compound of formula 4 where c is hydrogen or chlorine and one or both of a and b are fluorine or chlorine.

### EXAMPLE 21

The compound of Example 1 was dyed by exhaust dyeing.

The bleach fastness of the fabric was tested using the UK-TO test. A wash liquor was prepared by dispensing 10 grams of ECE detergent powder with 1.8 grams TAED at 100% and 12 grams sodium perborate per litre of water. These ingredients were dispersed vigorously at 20° C. for 10 minutes. Specimens of dyed fabric measia-ring 5 by 10 centimetres which had been weighed were placed in a dyeing machine together with the wash liquor to provide a liquor to goods ratio of 100 to 1. The temperature was raised from 20° C. to 60° C. in 22 minutes and the test continued at 60° C. for a further 30 minutes. The specimens were remtoved at the end of the wash and placed in a 4 litre beaker half filled with water. The specimens were gently agitated and then rinsed for one minute. The specimens were placed under a cold running tap for 10 minutes and squeezed to remove excess water.

After air drying, the specimens were assessed for colour change using a spectraflash 600 spectrophotometer against unexposed standards. As a comparison, CI Reaction Black 5 was also tested in a similar manner on a similar fabric. The compound of Example 1 passed the UK-TO test unambiguously at depths of shade k/s equalling 13 and k/s 26 and showed a change in shade (DE CIE lab) of 1.5 and 2.1 units respectively. By contrast, pieces of the same fabric dyed with CI Reactive Black 5 at depths of shade equalling k/s=13 and k/s=26, showed a change of shade of 7.2 and 2.3 respectively. The smaller the change in shade, the more resistant is the material to bleach fading.

In another comparative test, the compound of formula 3 in which X is chlorine and R₁ and both R₂ groups are hydrogen gives better performance than the compound in which X and R₁ and one of the R₂ groups is hydrogen and the other R₂ group is chlorine.

1. A compound of Formula 3 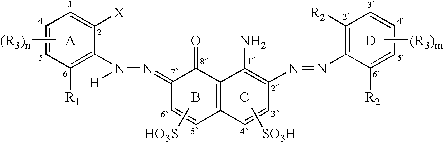
wherein X is fluorine, chlorine, bromine or iodine; R₁ is fluorine, chlorine, bromine, iodine, hydrogen or R₃; R₂ substituents are the same or different and are H or R₃: R₃ substituents are the same or different and are selected from —SO₃H, —NO₂, a fibre-reactive group or any moiety linked to the benzene ring by a carbon atom; n is 0, 1, 2 or 3; m is 0, 1, 2 or 3; and water soluble salts thereof.

2. A compound according to claim 1 in which X is chlorine or bromine, R₁ is hydrogen, chlorine or bromine and R₂ are both hydrogen or one is hydrogen and the other is —SO₃H.

3. A compound according to claim 2 in which X is chlorine and R₁ is hydrogen or chlorine.

4. A compound according to claim 1, wherein the fiber-reactive group R₃ is meta or para to the azo group in ring A.

5. A compound according to claim 1, wherein the only substituent R₃ in ring A is SES meta or para to the azo group and ring D is unsubstituted or contains SES meta or para to the azo group.

6. Yarn or fabric containing cellulosic, wool or polyamide fibers dyed with a dye comprising the compound according to claim 1.

7. A method for dyeing cellulosic, wool or polyamide fibers to produce a dyed yarn or fabric which has enhanced dye fastness relative to Reactive Black 5 when washed in aqueous detergent containing peroxy bleach, the method comprising dyeing the fibers with a dye comprising the compound of claim 1.

8. A method for dyeing cellulosic, wool or polyamide fibers to produce a dyed yarn or fabric which has been shown to have enhanced dye fastness relative to the Reactive Black 5 when washed in aqueous detergent containing a peroxy bleach, the method comprising dyeing the fibers with a dye comprising the compound according to claim 1.
